(19) United States
(12) Patent Application Publication
(10) Pub. No.: US 2006/0093739 A1
(43) Pub. Date: May 4, 2006

(54) Chemical treating composition for forming hydrophilic and fuzziness-proof surfaces on a glass substrate and utilizing methods for the chemical treating composition

(76) Inventors: Wen-Chuan Liu, Hsi-Chih City (TW); Chien-Kuo Huang, Hsi-Chih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/976,803

(22) Filed: Nov. 1, 2004

(51) Int. Cl. B05D 5/06; B05D 3/12; B05D 5/00; C04B 14/00

(52) U.S. Cl. 427/240; 427/162; 427/243; 106/400

(57) ABSTRACT

A chemical treating composition for forming hydrophilic and fuzziness-proof surfaces on a glass substrate, wherein the chemical treating composition contains silicon dioxide particles within 100 nm diameter, a polysiloxane derivative, ammonium hydrogen fluoride (ammonium bifluoride), ammonium fluosilicate, a surfactant agent, hydrogen peroxide, phosphate anion and water. The chemical treating composition modifies the glass substrate on surfaces and makes the surfaces porous to increase hydrophilic capability of the glass substrate, wherein boundary angles of water droplets and the glass substrate are less than 30°.

### BACKGROUND OF THE INVENTION

1. Field of the Invention

The present invention relates to a chemical treating composition, and more particularly to a chemical treating composition that produces hydrophilic and fuzziness-proof surfaces on a glass substrate. Utilizing methods for the chemical treating composition are also disclosed in the present invention.

2. Description of Related Art

To make a glass substrate have hydrophilic and fuzziness-proof capabilities, several conventional chemicals, such as polyvinyl acetate (PVA), polyvinyl methyl ether (PVME), surfactants and semiconducting photo-catalysts, are suitable to coat on surfaces of the glass substrate in the form of a membrane. After the membrane has solidified, water or moisture easily disperses on the membrane to keep the glass substrate clear and transparent when water or moisture touches the surfaces of the glass substrate. However, the membranes made of these chemicals have poor durability and abrasion resistance.

With regard to conventional processing methods of forming the hydrophilic and fuzziness-proof membranes on the glass substrate, the conventional processing methods are spraying coating, sopping coating, applying coating and vapor deposition coating. The sopping coating, spraying coating and vapor deposition coating are used on intermediate products and are not suitable for final products. The spraying coating is used more often than other methods but still inconvenient.

However, poor durability is still the main problem of the hydrophilic and fuzziness-proof membrane and this is manifested as the aging problem. Because the membrane is achieved by exterior processes to coat the glass substrate and is made of compounds, the membrane has poor climate-enduring efficiency, poor washing-enduring efficiency and poor touch-enduring efficiency, as well as easily separating from the glass substrate.

With regard to a membrane made of a semiconducting photo-catalyst, this membrane needs sufficient light to provide its hydrophilic and fuzziness-proof efficiencies. Therefore, membranes made of these conventional chemicals still have drawbacks either in their physical properties or in their utilizing methods.

The present invention has arisen to mitigate or obviate the disadvantages of forming a hydrophilic and fuzziness-proof membrane on the glass substrate.

### SUMMARY OF THE INVENTION

A main objective of the present invention is to provide a chemical treating composition for forming hydrophilic and fuzziness-proof surfaces that have excellent durability and enable to be keep the glass substrate at any places without sufficient lighting.

To achieve the foregoing objective, the chemical treating composition makes porous surfaces on the glass substrate and changes surface electronic properties to make the glass substrate hydrophilic.

The chemical treating composition substantially comprises silicon dioxide particles with 100 nm diameter, a polysiloxane derivative, ammonium hydrogen fluoride (ammonium bifluoride), ammonium fluosilicate, ammonium chloride, a surfactant agent, hydrogen peroxide, phosphate anion and water.

Because the chemical treating composition makes the glass substrate have porous surfaces, creates hydrophilic binding of Si—OH and changes the surface electronic properties of the glass substrate, the porous surfaces are hydrophilic. Moreover, as the porous surfaces are integral with the glass substrate and have no intermediate layers to combine with the glass substrate, the porous surfaces are firmly formed on the glass substrate and not easily separated from the glass substrate. Therefore, the glass substrate is durable in its hydrophilic and fuzziness-proof efficiencies.

Further benefits and advantages of the present invention will become apparent after a careful reading of the detailed description.

### DETAILED DESCRIPTION OF THE PREFERRED EMBODIMENT

A chemical composition for forming hydrophilic and fuzziness-proof membrane in accordance with the present invention is mainly used on certain glass substrates such as lenses, mirrors or other irregular glass objects needing the hydrophilic and fuzziness-proof efficiencies. After treating the glass substrate with the chemical treating composition, water droplets are easily dispersed on the hydrophilic porous surfaces and a boundary angle between the droplet and the surface is less than 30° so that the water droplet is almost eliminated and what little water exists flattens on the glass substrate to prevent fuzziness. Therefore, reflection and interferences caused from the water droplets are avoided and the glass substrate still remains clear after the glass substrate contacts with water or fine moisture.

The chemical treating composition in the present invention substantially comprises silicon dioxide particles within 100 nm diameter, a polysiloxane derivative, ammonium hydrogen fluoride (ammonium bifluoride), ammonium fluosilicate, ammonium chloride, a surfactant agent, hydrogen peroxide, phosphate anion and water.

Because glass substrate is composed of silicon dioxide, when the glass substrate is molded at high temperature, crystal water is dehydrated from the glass substrate so that the glass substrate is hydrophobic. When the chemical treating composition is applied to the glass substrate, surfaces of the glass substrate is etched to perform porosity and improved in molecular structure to create hydrophilic binding of Si—OH that makes the glass substrate hydrophilic.

The glass substrate is not hydrophilic before treating with the chemical treating composition, and the boundary angle between the water droplet and the glass substrate is over 50°-60°. Therefore, the water droplets gather and bulge such that reflections and interferences that cause the glass substrate vague.

The surfactant agent in the chemical treating composition is selectively an anion surfactant, a non-ionized surfactant and a cation surfactant. These surfactants are respectively introduced as the following:

a. The anion surfactant is selected from the group consisting of: ammonium polyoxyethylene alkyl phenyl ether sulfonate, sodium polyoxyethylene alkyl phenyl ether sulfonate, fatty acid potassium soap, sodium succinate, alkyl sulfate, and sodium alkyl sulfate.

b. The non-ionized surfactant is selected from the group consisting of: polyoxyethylene p-octyl phenol ether, polyoxyethylene p-octyl laurate, polyoxylethylene oleoyl ether, polyoxyethylene stearoyl ether, polyether modified siloxane, and oleic diethanolamide.

c. The cation surfactant is selected from the group consisting of: dimethylalkyl betain, perfluoroalkylaminosulfonate, alkyltrimethyl ammonium chloride, didecyldimethyl ammonium chloride, alkylpropylene diamine acetate, docosanyltrimethylammonium chloride, and perfluoroalkyl quaternary ammonium.

The polysiloxane derivative is preferably-selected from the group consisting of: methyltrimethoxysilane, methyltriethoxy silane, ethyl tri-butoxyl silane, trimethyldiethylsilane, phenylmethyldimethoxysilane, n-propyl triethoxylsilane, n-propyltripropoxylsilane, and methyl tributoxyl silane.

Utilizing methods for the chemical treating composition in the present invention are listed and further illustrated as following:

Dip coating: Operational conditions in the dip coating are that temperature of the chemical treating composition is 5 to 95° C., reacting time of the chemical treating composition to react with the glass substrate is 0.1 sec to 2 hours, and pH value of the chemical treating composition is 1.0 to 12.0.

Spray coating: Operational conditions in the spray coating are that temperature of the chemical treating composition is 5 to 95° C., reacting time of the chemical treating composition to react with the glass substrate is 0.1 sec to 2 hours, spray rate of the chemical treating composition is 0.001 ml/min to 100 L/min, and pH value of the chemical treating composition is 1.0 to 12.0.

Apply coating: Operational conditions in the application of coating are that temperature of the chemical treating composition is 5 to 95° C., reacting time of the chemical treating composition to react with the glass substrate is 0.1 sec to 2 hours, coating thickness of the chemical treating composition is 10 nm to 1 cm, and pH value of the chemical treating composition is 1.0 to 12.0.

Spin coating: Operational conditions in the spin coating are that temperature of the chemical treating composition is 5 to 95° C., reacting time of the chemical treating composition to react with the glass substrate is 0.1 sec to 2 hours, spin speed is 0.001 rpm to 10,000 rpm, flow rate of the chemical treating composition is 0.001 ml/min to 100 L/min, coating thickness of the chemical treating composition is 10 nm to 1 cm, and pH value of the chemical treating composition is 1.0 to 12.0.

The preferred embodiment of the chemical treating composition is composed of 0.0001 to 5 (w/w) % of silicon dioxide, 0.0001 to 5 (w/w) % of the polysiloxane derivative, 0.0001 to 25 (w/w) % of ammonium hydrogen fluoride, 0.0001 to 10 (w/w) % of ammonium fluosilicate, 0.0001 to 15 (w/w) % of ammonium chloride, 0.0001 to 20 (w/w) % of the surfactant agent, 0.0001 to 20 (w/w) % of hydrogen peroxide, 0.0001 to 10 (w/w) % of phosphate anion and water taking residual proportions of the chemical treating composition. All weight percentages shown in the present invention are obtained by dividing weights of designated compounds to a total weight of the chemical treatment composition.

Preferably, the substrate is washed with water to remove residual chemical treating composition remained on the substrate.

### EXAMPLES

Preferred embodiments for forming hydrophilic and fuzziness-proof surfaces on a glass substrate are illustrated in the following six examples.

### Example 1

A piece of glass substrate with 5 mm thickness was obtained. The glass substrate was selectively tempered glass, non-tempered glass, colored glass, colorless or half-reflecting glass. The glass substrate was cleaned and dipped into the chemical treating composition that was composed of 3 (w/w) % of silicon dioxide particles having diameters less than 100 nm, 5 (w/w) % of the polysiloxane derivative, 21 (w/w) % of ammonium hydrogen fluoride, 6 (w/w) % of ammonium fluosilicate, 10 (w/w) % of ammonium chloride, 17 (w/w) % of the surfactant agent, 7 (w/w) % of hydrogen peroxide, 8 (w/w) % of phosphate anion and 23 (w/w) % of water. The chemical treating composition is in liquid form.

The temperature of the chemical treating composition was 30° C. and pH value of the chemical treating composition was 6.7. The glass substrate was dipped in the chemical treating composition for 60 sec. After dipping, the glass substrate was cleaned by water to remove the chemical treating composition and dried to obtain the glass substrate having porous surfaces. Then, the glass substrate was moisturized with water or vapor to observe the contact of the water droplets with the porous surfaces of the glass substrate. The boundary angles between the water droplets and the glass substrate were less than 30°. Therefore, the porous surfaces of the glass substrate were hydrophilic and fuzziness-proof.

### Example 2

A piece of mirror substrate with 3 mm thickness was obtained. The mirror was selectively tempered mirror, non-tempered mirror, colored mirror, colorless mirror, chromium-coated mirror or anti-dazzling mirror. The mirror substrate was cleaned and dipped into the chemical treating composition that was composed of 3 (w/w) % of silicon dioxide particles having diameters less than 100 nm, 5 (w/w) % of the polysiloxane derivative, 20 (w/w) % of ammonium hydrogen fluoride, 6 (w/w) % of ammonium fluosilicate, 10 (w/w) % of ammonium chloride, 17 (w/w) % of the surfactant agent, 7 (w/w) % of hydrogen peroxide, 8 (w/w) % of phosphate anion and 24 (w/w) % of water. The chemical treating composition is in liquid form

The temperature of the chemical treating composition was 45° C. and pH value of the chemical treating composition was 5.7. The mirror substrate was dipped in the chemical treating composition for 70 sec. After dipping, the mirror substrate was cleaned by water to remove the chemical treating composition and dried to obtain the mirror substrate having porous surfaces. Then, the mirror substrate was moisturized with water or vapor to observe the contact of the water droplets with the porous surfaces of the mirror substrate. The boundary angles between the water droplets and the glass substrate were less than 30°. Therefore, the porous surfaces of the mirror substrate were hydrophilic and fuzziness-proof.

### Example 3

A piece of 4 mm lens substrate for a hydroscope was obtained. The lens substrate was selectively tempered lens, non-tempered lens, colored lens or colorless lens. The lens substrate was cleaned and processed by spray coating to apply the chemical treating composition that was composed of 3 (w/w) % of silicon dioxide particles having diameters less than 100 nm, 5 (w/w) % of the polysiloxane derivative, 20 (w/w) % of ammonium hydrogen fluoride, 6 (w/w) % of ammonium fluosilicate, 10 (w/w) % of ammonium chloride, 17 (w/w) % of the surfactant agent, 7 (w/w) % of hydrogen peroxide, 8 (w/w) % of phosphate anion and 24 (w/w) % of water. The chemical treating composition is in liquid form.

The temperature of the chemical treating composition was 35° C. and pH value of the chemical treating composition was 5.7. Spray pressure was 1.5 kg/cm² and spray rate of the chemical treating composition was 100 ml/min. The lens substrate was coated with 0.3 cm coating of the chemical treating composition and was modified with the chemical treating composition for 25 sec. After modifying, the lens substrate was cleaned by water to remove the chemical treating composition and dried to obtain the lens substrate having porous surfaces. Then, the lens substrate was moisturized with water or vapor to observe the contact of the water droplets with the porous surfaces of the lens substrate. The boundary angles between the water droplets and the lens substrate were less than 30°. Therefore, the porous surfaces of the lens substrate were hydrophilic and fuzziness-proof.

### Example 4

A piece of architectural glass substrate with 10 mm thickness was obtained. The glass substrate was selectively tempered glass, non-tempered glass, colored glass or colorless glass. The glass substrate was cleaned and processed by apply coating to apply the chemical treating composition on the glass substrate. The chemical treating composition was composed of 3 (w/w) % of silicon dioxide particles having diameters less than 100 nm, 5 (w/w) % of the polysiloxane derivative, 20 (w/w) % of ammonium hydrogen fluoride, 6 (w/w) % of ammonium fluosilicate, 10 (w/w) % of ammonium chloride, 17 (w/w) % of the surfactant agent, 7 (w/w) % of hydrogen peroxide, 8 (w/w) % of phosphate anion and 24 (w/w) % of water. The chemical treating composition is in liquid form.

The temperature of the chemical treating composition was 25° C. and pH value of the chemical treating composition was 5.7. The glass substrate was coated with 0.25 cm coating of the chemical treating composition and was modified with the chemical treating composition for 150 sec. After modifying, the glass substrate was cleaned by water to remove the chemical treating composition and dried to obtain the glass substrate having porous surfaces. Then, the glass substrate was moisturized with water or vapor to observe the contact of the water droplets with the porous surfaces of the glass substrate. The boundary angles between the water droplets and the glass substrate were less than 30°. Therefore, the porous surfaces of the glass substrate were hydrophilic and fuzziness-proof.

### Example 5

A piece of flat transparent glass substrate with 10 mm thickness was obtained. The glass substrate was selectively tempered glass, non-tempered glass, colored glass or colorless glass. The glass substrate was cleaned and processed by spin coating to apply the chemical treating composition that was composed of 3 (w/w) % of silicon dioxide particles having diameters less than 100 nm, 5 (w/w) % of the polysiloxane derivative, 20 (w/w) % of ammonium hydrogen fluoride, 6 (w/w) % of ammonium fluosilicate, 10 (w/w) % of ammonium chloride, 17 (w/w) % of the surfactant agent, 7 (w/w) % of hydrogen peroxide, 8 (w/w) % of phosphate anion and 24 (w/w) % of water. The chemical treating composition is in liquid form.

The temperature of the chemical treating composition was 28° C. and pH value of the chemical treating composition was 5.7. Spin speed was 100 rpm and flow rate was 300 ml/min. The glass substrate was coated with 0.5 cm coating of the chemical treating composition and was modified with the chemical treating composition for 45 sec. After modifying, the glass substrate was rotated at 500 rpm to get rid of the chemical treating composition on the glass substrate. Then, the glass substrate was cleaned by water to remove the residual chemical treating composition and dried to obtain the glass substrate having porous surfaces. Then, the glass substrate was moisturized with water or vapor to observe the contact of the water droplets with the porous surfaces of the glass substrate. The boundary angles between the water droplets and the glass substrate were less than 30°. Therefore, the porous surfaces of the glass substrate were hydrophilic and fuzziness-proof.

### Example 6

A transparent glass cup was obtained. The glass substrate was selectively a tempered glass cup, non-tempered glass cup, colored glass cup or a colorless glass cup. The glass cup was cleaned and dipped in the chemical treating composition that was composed of 3 (w/w) % of silicon dioxide particles having diameters less than 100 nm, 5 (w/w) % of the polysiloxane derivative, 21 (w/w) % of ammonium hydrogen fluoride, 6 (w/w) % of ammonium fluosilicate, 10 (w/w) % of ammonium chloride, 17 (w/w) % of the surfactant agent, 7 (w/w) % of hydrogen peroxide, 8 (w/w) % of phosphate anion and 23 (w/w) % of water. The chemical treating composition is in liquid form.

The temperature of the chemical treating composition was 35° C. and pH value of the chemical treating composition was 5.7. The glass cup was dipped in the chemical treating composition for 30 sec. After dipping, the glass cup was cleaned by water to remove the chemical treating composition and dried to obtain the glass cup having porous surfaces. Then, the glass cup was moisturized with water or vapor to observe the contact of the water droplets with the porous surfaces of the glass cup. The boundary angles between the water droplets and the glass cup were less than 30°. Therefore, the porous surfaces of the glass cup were hydrophilic and fuzziness-proof.

Although the invention has been explained in relation to its preferred embodiment, many other possible modifications and variations can be made without departing from the spirit and scope of the invention as hereinafter claimed.

What is claimed is:

1. A chemical treating composition for forming hydrophilic and fuzziness-proof surfaces on a glass substrate, the chemical treating composition comprising: silicon dioxide particles within 100 nm diameter, polysiloxane derivative, ammonium hydrogen fluoride (ammonium bifluoride), ammonium fluosilicate, ammonium chloride, a surfactant agent, hydrogen peroxide, phosphate anion and water.

2. The chemical treating composition as claimed in claim 1, wherein proportions of chemical treating composition are:
0.0001 to 5 (w/w) % of silicon dioxide;
0.0001 to 5 (w/w) % of the polysiloxane derivative;
0.0001 to 25 (w/w) % of ammonium hydrogen fluoride;
0.0001 to 15 (w/w) % of ammonium fluosilicate,
0.0001 to 10 (w/w) % of ammonium chloride;
0.0001 to 20 (w/w) % of surfactant agents;
0.0001 to 10 (w/w) % of hydrogen peroxide;
0.0001 to 10 (w/w) % of phosphate anion; and
water that takes residual proportions of the chemical treating composition.

3. The chemical treating composition as claimed in claim 1, wherein the surfactant agent is an anion surfactant selected from the group consisting of: ammonium polyoxyethylene alkyl phenyl ether sulfonate, sodium polyoxyethylene alkyl phenyl ether sulfonate, fatty acid potassium soap, sodium succinate, alkyl sulfate, and sodium alkyl sulfate.

4. The chemical treating composition as claimed in claim 1, wherein the surfactant agent is a non-ionized surfactant selected from the group consisting of: polyoxyethylene p-octyl phenol ether, polyoxyethylene p-octyl laurate, polyoxylethylene oleoyl ether, polyoxyethylene stearoyl ether, polyether modified siloxane, and oleic diethanolamide.

5. The chemical treating composition as claimed in claim 1, wherein the surfactant agent is a cation surfactant selected from the group consisting of: dimethylalkyl betain, perfluoroalkylaminosulfonate, alkyltrimethyl ammonium chloride, didecyldimethyl ammonium chloride, alkylpropylene diamine acetate, docosanyltrimethylammonium chloride, and perfluoroalkyl quaternary ammonium.

6. The chemical treating composition as claimed in claim 1, wherein the polysiloxane derivative is preferably selected from the group consisting of: methyltrimethoxysilane, methyltriethoxy silane, ethyl tri-butoxyl silane, trimethyldiethylsilane, phenylmethyldimethoxysilane, n-propyl triethoxylsilane, n-propyltripropoxylsilane, and methyl tributoxyl silane.

7. A utilizing method for forming hydrophilic and fuzziness-proof surfaces on a glass substrate, wherein the utilizing method is to coat the chemical treating composition in claim 1 on the glass substrate to make porous surfaces on the glass substrate.

8. The utilizing method as claimed in claim 7, wherein the glass substrate is coated with the chemical treating composition by a dip coating and operational conditions of the dip coating are:
temperature of the chemical treating composition: 5 to 95° C.;
reacting time of the chemical treating composition to react with the glass substrate: 0.1 sec to 2 hours; and
pH value of the chemical treating composition: 1.0 to 12.0.

9. The utilizing method as claimed in claim 7, wherein the glass substrate is coated with the chemical treating composition by a spray coating and operational conditions of the spray coating are:
temperature of the chemical treating composition: 5 to 95° C.;
reacting time of the chemical treating composition to react with the glass substrate: 0.1 sec to 2 hours;
spray rate of the chemical treating composition: 0.001 ml/min to 100 L/min; and
pH value of the chemical treating composition: 1.0 to 12.0.

10. The utilizing method as claimed in claim 7, wherein the glass substrate is coated with the chemical treating composition by a apply coating and operational conditions of the spray coating are:
temperature of the chemical treating composition: 5 to 95° C.;
reacting time of the chemical treating composition to react with the glass substrate: 0.1 sec to 2 hours;
coating thickness of the chemical treating composition: 10 nm to 1 cm; and
pH value of the chemical treating composition: 1.0 to 12.0.

11. The utilizing method as claimed in claim 7, wherein the glass substrate is coated with the chemical treating composition by a spin coating and operational conditions of the spin coating are:
temperature of the chemical treating composition: 5 to 95° C.;
reacting time of the chemical treating composition to react with the glass substrate: 0.1 sec to 2 hours;
spin speed: 0.001 rpm to 10,000 rpm;
flow rate of the chemical treating composition: 0.001 ml/min to 100 L/min
coating thickness of the chemical treating composition: 10 nm to 1 cm; and
pH value of the chemical treating composition: 1.0 to 12.0.
